(19) United States
(12) Patent Application Publication
(10) Pub. No.: US 2013/0329400 A1
(43) Pub. Date: Dec. 12, 2013

(54) MIDDLE FRAME, BACKLIGHT MODULE, AND LCD DEVICE

(71) Applicants: Yicheng Kuo, Shenzhen (CN); Shihhsiang Chen, Shenzhen (CN); Jiaqiang Wang, Shenzhen (CN)

(72) Inventors: Yicheng Kuo, Shenzhen (CN); Shihhsiang Chen, Shenzhen (CN); Jiaqiang Wang, Shenzhen (CN)

(21) Appl. No.: 13/635,091

(22) PCT Filed: Jun. 12, 2012
(86) PCT No.: PCT/CN12/76761

§ 371 Date: Sep. 14, 2012

(30) Foreign Application Priority Data
Jun. 6, 2012 (CN) 201210183212.9

(51) Int. Cl. G02F 1/1333; G09F 13/04

(52) U.S. Cl. 362/97.2; 211/26.2; 362/97.1

(57) ABSTRACT

The present disclosure discloses a middle frame, a backlight module, and a liquid crystal display (LCD) device. The middle frame includes at least two middle frame assemblies joined in sequence. The middle frame further includes a splicer; a joining face of at least one of the middle frame assemblies is configured with a guide groove corresponding to at least two fixing positions, and the two adjacent middle frame assemblies are positioned by the splicer fixed in the guide groove. In the present disclosure, because the guide groove and the splicer are used, the relative position of the two adjacent middle frame assemblies can be adjusted according to LCD devices of different sizes, and the two adjacent middle frame assemblies are positioned by the splicer fixed in the guide grooves. Thus, the middle frame assemblies can be made into standardized universal parts, to be shared by various devices.

### TECHNICAL FIELD

The present disclosure relates to the field of liquid crystal displays (LCDs), and more particularly to a middle frame, a backlight module, and an LCD device.

### BACKGROUND

In a typical liquid crystal display (LCD) module, a middle frame is of an integrated structure or a joined structure of quartered members generally. The middle frame of an integrated structure has poor applicability. A kind of middle frame corresponds to a set of module. When a new device is developed, a middle frame should be redesigned. Thus, working load of engineer is added, development time and development cost of new devices are added, and certain difficulty is caused to the product field and line assembly, thereby causing time and capital waste, and causing disbenefit to the development of the whole product or the long development of enterprises.

### SUMMARY

In view of the above-described problems, the aim of the present disclosure is to provide a middle frame, a backlight module, and a liquid crystal display (LCD) device capable of being shared by various devices.

The aim of the present disclosure is achieved by the following technical scheme.

A middle frame comprises at least two middle frame assemblies joined in sequence, and the middle frame further comprises a splicer. A joining face of at least one of the middle frame assemblies is configured with a guide groove corresponding to at least two fixing positions, and two adjacent middle frame assemblies are positioned by the splicer fixed in the guide groove.

In one example, the guide groove is a strip-shaped sliding chute. The middle frame assembly comprises a middle frame assembly with the guide groove and a splicing middle frame assembly. A joining face of the middle frame assembly with the guide groove is configured with the guide groove, and a joining face of the splicing middle frame assembly is configured with the splicer. The splicer is integrated onto the middle frame assembly, thereby reducing the types of components, and facilitating the material preparation and assembly of production.

In one example, the guide groove comprises a fixing part with constant groove width. At least one end of the fixing part is configured with a guide part, and the groove width of the guide part is more than that of the fixing part; accordingly, both ends of the splicing middle frame assembly are configured with one splicer, respectively. The splicer is a lug head. The lug head comprises a root part connected with the splicing middle frame assembly and an end part connected with the root part. The width of the end part of the lug head is more than that of the root part, and is matched with that of the guide part of the guide groove; the width of the root part of the lug head is matched with that of the fixing part of the guide groove. The two lug heads of the splicing middle frame assembly are respectively matched with the guide grooves of the two different middle frame assemblies with the guide groove. The end part of the lug head is inserted in the guide groove from the guide part, after that, the relative position of the two middle frame assemblies is adjusted, which enable the root part of the lug head to slip into the fixing part of the guide groove. Because the width of the end part of the lug head is more than that of the root part of the lug head and the fixing part of the guide groove, after the lug head slips into the fixing part, two adjacent middle frame assemblies cannot be separated, thereby achieving the positioning.

In one example, both the fixing part and the guide part are in rectangle shape, and are axially symmetrical in the length direction of the guide groove. Accordingly, the root part and the end part of the lug head are in cube shape, the end part is superposed on the root part, and the whole lug head is in a T shape. This is one specific shape of the guide groove and the lug head.

In one example, the joining face of the middle frame assembly with the guide groove comprises a first joining face and a second joining face which are perpendicular to each other. The first joining face is configured with a first guide groove, and the second joining face is configured with a second guide groove. The joining face of the splicing middle frame assembly comprises a third joining face and a fourth joining face; the third joining face is configured with a first splicer matched with the first guide groove, and the fourth joining face is configured with a second splicer matched with the second guide groove. This is one mode of positioning at both sides. The middle frame assemblies are mutually and firmly fixed.

In one example, the first guide groove comprises a fixing part with constant groove width. At least one end of the fixing part is configured with a guide part, and the groove width of the guide part is more than that of the fixing part. Accordingly, the first splicer comprises a first lug head. The first lug head comprises a root part connected with the splicing middle frame assembly and an end part connected with the root part. T he width of the end part of the first lug head is more than that of the root part, and is matched with that of the guide part of the first guide groove; the width of the root part of the first lug head is matched with that of the fixing part of the first guide groove. The end part of the first lug head is inserted in the first guide groove from the guide part, after that, the relative position of the middle frame assembly with the guide groove and the splicing middle frame assembly is adjusted, which enable the root part of the first lug head to slip into the fixing part of the first guide groove. Because the width of the end part of the first lug head is more than that of the root part and the fixing part of the first guide groove, after the first lug head slips into the fixing part, two middle frame assemblies cannot be separated, thereby achieving the positioning.

In one example, the second guide groove comprises a plurality of round holes which intersect in sequence, and the second splicer comprises a second lug head which is cylindrical. This is another matching mode of the guide groove and the splicer. The second guide groove is formed by a plurality of round holes which are arranged in an intersecting mode, and is in a sugared hawkthorns shape. The second lug head is in a cylindrical shape, and the second lug head is directly inserted into any round hole or slips to any round hole in the second guide groove. Thus, the relative position of the two middle frame assemblies can be fixed. Therefore, the technical scheme can provide a plurality of positioning points, to improve the positioning effect.

In one example, the first splicer and the second splicer are positioned at the same end of the splicing middle frame assembly. This is one technical scheme of mutually positioning two middle frame assemblies. Thus, the first splicer and the second splicer are matched with the guide groove of the same middle frame assembly with the guide groove, the middle frame assembly with the guide groove and the splicing middle frame assembly are firmly positioned.

In one example, the first splicer and the second splicer are respectively arranged at both ends of the splicing middle frame assembly, and are respectively matched with the guide grooves of two different middle frame assemblies with the guide groove. This is one technical scheme of cascade joining of different middle frame assemblies. The same middle frame assembly with the guide groove joins two different splicing middle frame assemblies; thus, the joining mode becomes flexible.

In one example, the middle frame assembly is configured with the guide groove. After two adjacent middle frame assemblies are joined, two guide grooves are partially overlapped, the splicer is fixed in the overlapped guide groove of two middle frame assemblies, and two adjacent middle frame assemblies are positioned. Thus, the middle frames of different devices can be formed by only joining one type of middle frame assembly, and the types of components can be reduced, thereby favoring the saving of mold cost, and facilitating the subsequent material preparation and assembly operation.

A backlight module comprises the middle frame mentioned above.

An LCD device comprises the backlight module mentioned above.

In the present disclosure, because the guide groove and the splicer are used, the relative position of two adjacent middle frame assemblies can be adjusted according to LCD devices of different sizes, and two adjacent middle frame assemblies are positioned by the splicer fixed in the guide groove. Thus, the middle frame assemblies can be made into standardized universal parts, to be shared by various devices.

### BRIEF DESCRIPTION OF FIGURES

FIG. 1 is an effect diagram of a first example of the present disclosure;

FIG. 2 is a schematic diagram of a splicing middle frame assembly of a first example of the present disclosure;

FIG. 3 is an effect diagram of a second example of the present disclosure;

FIG. 4 is a schematic diagram of a splicing middle frame assembly of a second example of the present disclosure;

FIG. 5 is a schematic diagram of another assembly of a second example of the present disclosure; and

FIG. 6 is an effect diagram of a third example of the present disclosure.

Legends: 100. middle frame assembly with a guide groove; 200. splicing middle frame assembly; 410. first joining face; 420. second joining face; 430. third joining face; 440. fourth joining face; 500. guide groove; 510. first guide groove; 511. guide part; 512. fixing part; 520. second guide groove; 600. lug head; 610. first lug head; 611. root part; 612. end part; 620. second lug head; 700. splicer.

### DETAILED DESCRIPTION

An LCD device comprises an LCD panel and a backlight module. The backlight module comprises a middle frame. The middle frame comprises at least two middle frame assemblies joined in sequence, the middle frame further comprises a splicer. A joining face of at least one of the middle frame assemblies is configured with a guide groove corresponding to at least two fixing positions, and two adjacent middle frame assemblies are positioned by the splicer fixed in the guide groove.

In the present disclosure, because the guide groove and the splicer are used, the relative position of two adjacent middle frame assemblies can be adjusted according to LCD devices of different sizes, and two adjacent middle frame assemblies are positioned by the splicer fixed in the guide groove. Thus, the middle frame assemblies can be made into standardized universal parts, to be shared by various devices. The present disclosure will further be described in detail in accordance the examples.

### EXAMPLE 1

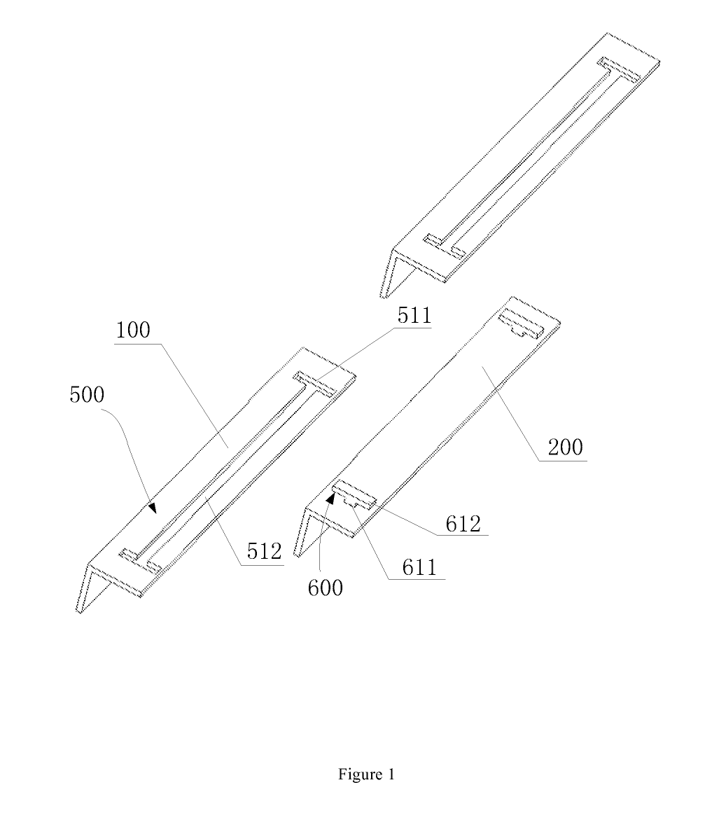

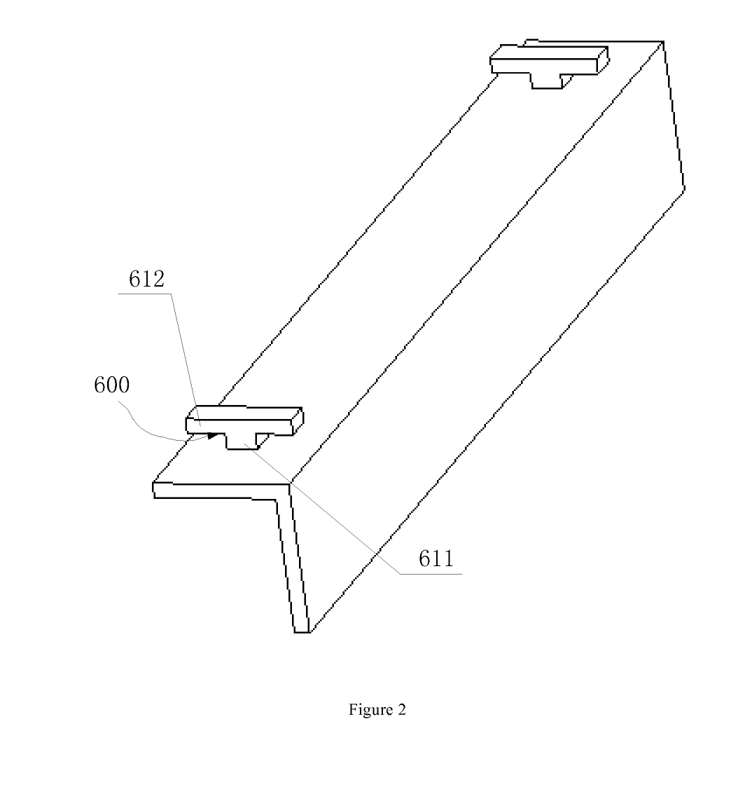

As shown in FIG. 1 and FIG. 2, a middle frame assembly comprises a middle frame assembly with a guide groove 100 and a splicing middle frame assembly 200. A joining face of the middle frame assembly with the guide groove is configured with a guide groove 500, and a joining face of the splicing middle frame assembly 200 is configured with a splicer. The splicer is integrated onto the middle frame assembly, thereby reducing the types of components, and facilitating the material preparation and assembly of production.

The guide groove 500 comprises a fixing part 512 with constant groove width. At least one end of the fixing part 512 is configured with a guide part 511, and the groove width of the guide part 511 is more than that of the fixing part 512. Accordingly, both ends of the splicing middle frame assembly 200 are configured with one splicer, respectively. The splicer is a lug head 600. The lug head 600 comprises a root part 611 connected with the splicing middle frame assembly 200 and an end part 612 connected with the root part 611. The width of the end part 612 of the lug head 600 is more than that of the root part 611, and is matched with that of the guide part 511 of the guide groove 500. The width of the root part 611 of the lug head 600 is matched with that of the fixing part 512 of the guide groove 500. Two lug heads 600 of the splicing middle frame assembly are respectively matched with the guide grooves 500 of the two different middle frame assemblies with the guide groove. The end part 612 of the lug head 600 is inserted in the guide groove 500 from the guide part 511, after that, the relative position of the two middle frame assemblies is adjusted, which enable the root part 611 of the lug head 600 to slip into the fixing part 512 of the guide groove 500. Because the width of the end part 612 of the lug head 600 is more than that of the root part 611 of the lug head 600 and the fixing part 512 of the guide groove 500, after the lug head 600 slips into the fixing part 512, two adjacent middle frame assemblies cannot be separated, thereby achieving the positioning.

Both the fixing part 512 and the guide part 511 are in rectangle shape, and are axially symmetrical in the length direction of the guide groove 500. Accordingly, the root part 611 and the end part 612 of the lug head 600 are in cube shape, the end part 612 is superposed on the root part 611, and the whole lug head 600 is in a T shape. Optionally, the guide groove 500 and the lug head 600 can also be in other shapes, all the structures belong to the conception of the present disclosure that both ends of the guide groove 500 are wide and the middle part thereof is narrow, and the width of the end part 612 of the lug head 600 is more than that of the root part 611.

### EXAMPLE 2

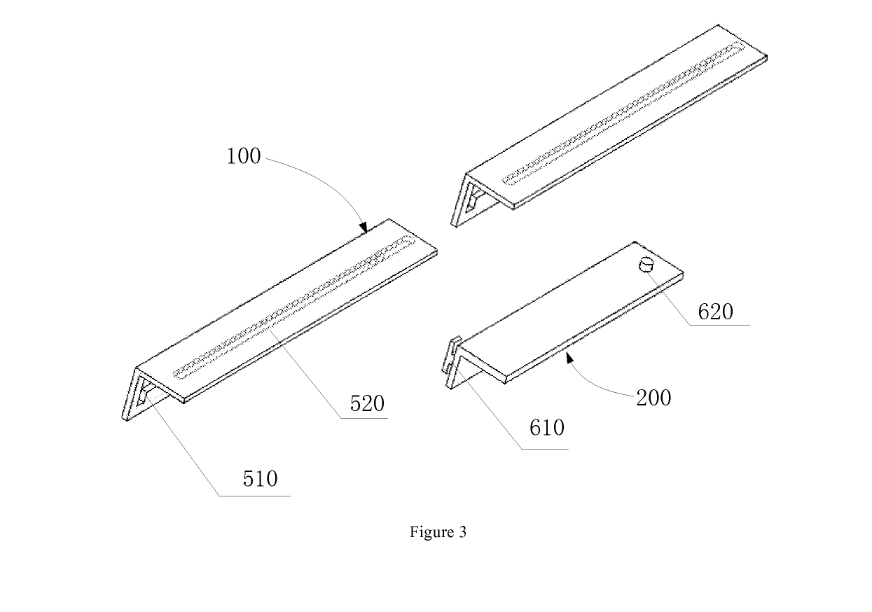

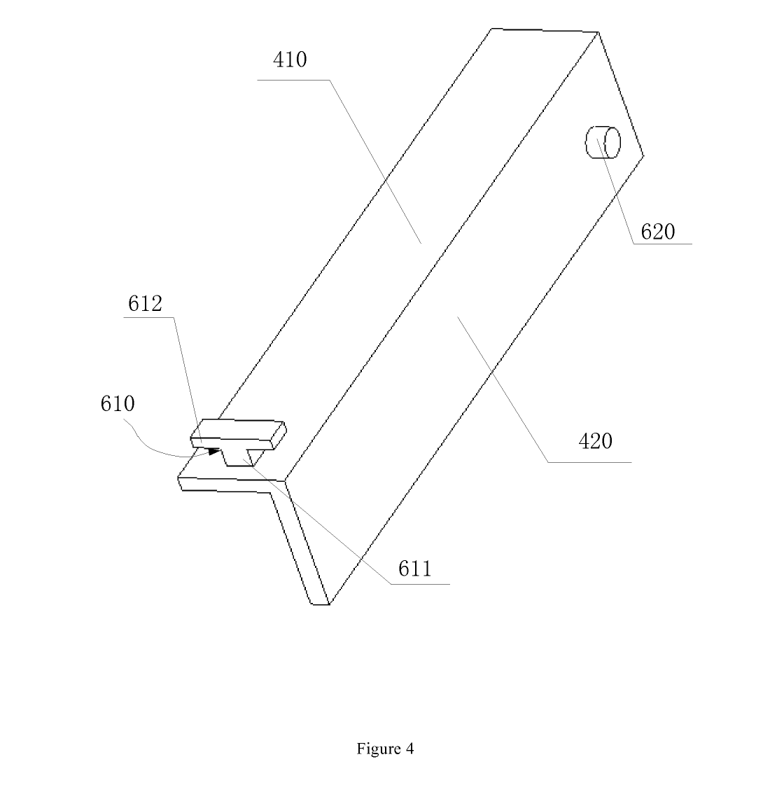

As shown in FIGS. 3-5, a joining face of a middle frame assembly with a guide groove 100 comprises a first joining face 410 and a second joining face 420 which are perpendicular to each other; the first joining face is configured with a first guide groove 510, and the second joining face 420 is configured with a second guide groove 520. A joining face of a splicing middle frame assembly 200 comprises a third joining face 430 and a fourth joining face 440. The third joining face 430 is configured with a first splicer matched with the first guide groove 510, and the fourth joining face 440 is configured with a second splicer matched with the second guide groove 520.

The first guide groove 510 comprises a fixing part 512 with constant groove width. At least one end of the fixing part 512 is configured with a guide part 511, and the groove width of the guide part 511 is more than that of the fixing part 512. Accordingly, the first splicer comprises a first lug head 610; the first lug head 610 comprises a root part 611 connected with the splicing middle frame assembly 200 and an end part 612 connected with the root part 611. The width of the end part 612 of the first lug head 610 is more than that of the root part 611, and is matched with that of the guide part 511 of the first guide groove 510; the width of the root part 611 of the first lug head 610 is matched with that of the fixing part 512 of the first guide groove 510. The end part 612 of the first lug head 610 is inserted in the first guide groove 510 from the guide part 511, after that, the relative position of the middle frame assembly with the guide groove 100 and the splicing middle frame assembly 200 is adjusted, which enable the root part 611 of the first lug head 610 to slip into the fixing part 512 of the first guide groove 510. Because the width of the end part 612 of the first lug head 610 is more than the width of the root part 611 of the first lug head 610 and the fixing part 512 of the first guide groove 510, after the first lug head 610 slips into the fixing part 512, two middle frame assemblies cannot be separated, thereby achieving the positioning.

The second guide groove 520 comprises a plurality of round holes which intersect in sequence, and the second splicer comprises a second lug head 620 which is cylindrical. The second guide groove 520 is formed by a plurality of round holes which are arranged in an intersecting mode, and is in a sugared hawkthorns shape. The second lug head 620 is in a cylindrical shape, and the second lug head 620 is directly inserted into any round hole or slips to any round hole in the second guide groove 520. Thus, the relative position of two middle frame assemblies can be fixed. Therefore, the technical scheme can provide a plurality of positioning points, to improve the positioning effect.

The first splicer and the second splicer are respectively arranged at both ends of the splicing middle frame assembly 200, and are respectively matched with the guide grooves of the two different middle frame assemblies with the guide groove. This is one technical scheme of cascade joining of different middle frame assemblies. The same middle frame assembly with the guide groove 100 joins the two different splicing middle frame assemblies 200; thus, the joining mode becomes flexible.

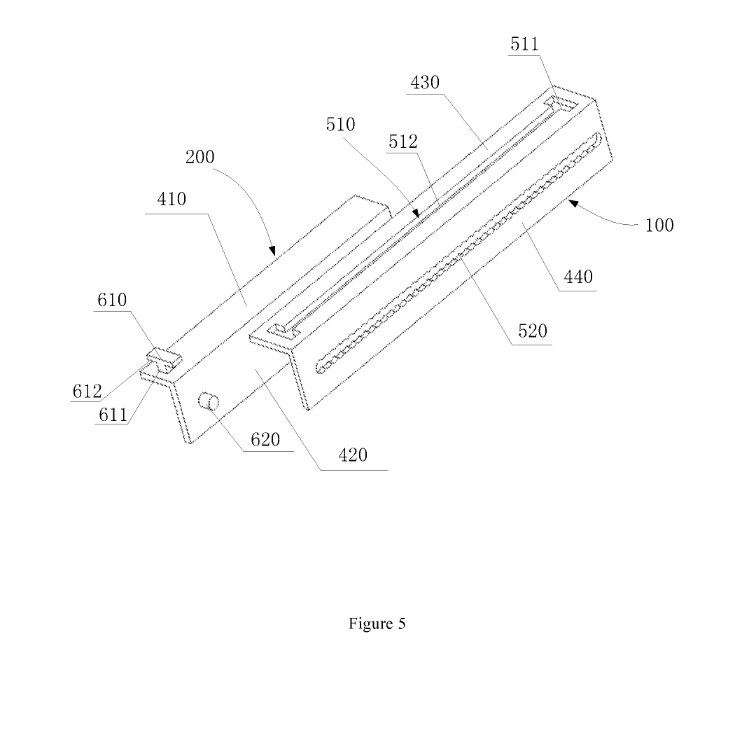

Optionally, as shown in FIG. 5, the first splicer and the second splicer are positioned at the same end of the splicing middle frame assembly 200. Thus, the first splicer and the second splicer are matched with the guide groove 500 of the same middle frame assembly with the guide groove 100, the middle frame assembly with the guide groove 100 and the splicing middle frame assembly 200 are mutually and firmly positioned.

### EXAMPLE 3

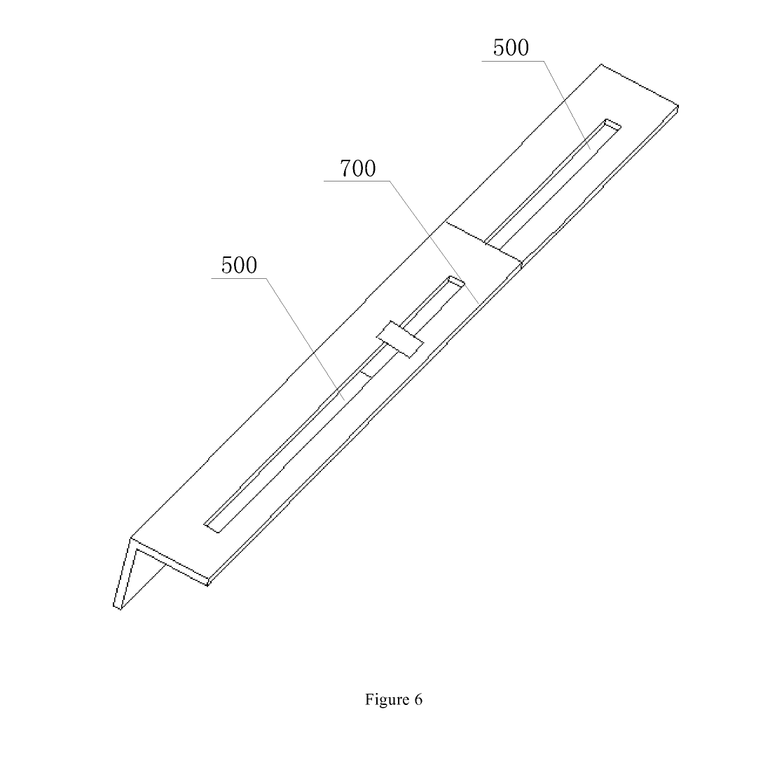

As shown in FIG. 6, a middle frame assembly is configured with a guide groove 500; after two adjacent middle frame assemblies are joined, two guide grooves 500 are partially overlapped, and a splicer 700 is fixed in the overlapped guide groove 500 of two middle frame assemblies, and two adjacent middle frame assemblies are positioned. In the example, the middle frames of different devices can be formed by only joining one type of middle frame assembly, and the types of components can be reduced, thereby favoring the saving of mold cost, and facilitating the subsequent material preparation and assembly operation.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, for example, the guide groove of the present disclosure can be formed by a plurality of installing holes, installing grooves, etc. in addition to the strip-shaped sliding chutes as long as the structures can correspond to a plurality of installing positions, and all of which should be considered to belong to the protection scope of the present disclosure.

We claim:

1. A middle frame, comprising:
at least two middle frame assemblies joined in sequence;
wherein the middle frame further comprises a splicer; a joining face of at least one of the middle frame assemblies is configured with a guide groove corresponding to at least two fixing positions, and the two adjacent middle frame assemblies are positioned by the splicer fixed in the guide groove.

2. The middle frame of claim 1, wherein the guide groove is a strip-shaped sliding chute; the middle frame assembly comprises a middle frame assembly with the guide groove and a splicing middle frame assembly; a joining face of the middle frame assembly with the guide groove is configured with the guide groove, and a joining face of the splicing middle frame assembly is configured with the splicer.

3. The middle frame of claim 2, wherein the guide groove comprises a fixing part with constant groove width; at least one end of the fixing part is configured with a guide part, and the groove width of the guide part is more than that of the fixing part; accordingly, both ends of the splicing middle frame assembly are configured with one splicer, respectively; the splicer is a lug head; the lug head comprises a root part connected with the splicing middle frame assembly and an end part connected with the root part; the width of the end part of the lug head is more than that of the root part, and is matched with that of the guide part of the guide groove; the width of the root part the lug head is matched with that of the fixing part of the guide groove; the two lug heads of the splicing middle frame assembly are respectively matched with the guide grooves of the two different middle frame assemblies with the guide groove.

4. The middle frame of claim 3, wherein both the fixing part and the guide part are in rectangle shape, and are axially symmetrical in the length direction of the guide groove; accordingly, the root part and end part of the lug head are in cube shape, the end part is superposed on the root part, and the whole lug head is in a T shape.

5. The middle frame of claim 2, wherein the joining face of the middle frame assembly with the guide groove comprises a first joining face and a second joining face which are perpendicular to each other; the first joining face is configured with a first guide groove, and the second joining face is configured with a second guide groove; the joining face of the splicing middle frame assembly comprises a third joining face and a fourth joining face; the third joining face is configured with a first splicer matched with the first guide groove, and the fourth joining face is configured with a second splicer matched with the second guide groove.

6. The middle frame of claim 5, wherein the first guide groove comprises a fixing part with constant groove width; at least one end of the fixing part is configured with a guide part, and the groove width of the guide part is more than that of the fixing part; accordingly, the first splicer comprises a first lug head, and the first lug head comprises a root part connected with the splicing middle frame assembly and an end part connected with the root part; the width of the end part of the first lug head is more than that of the root part, and is matched with that of the guide part of the first guide groove; the width of the root part is matched with that of the fixing part of the first guide groove.

7. The middle frame of claim 5, wherein the second guide groove comprises a plurality of round holes which intersect in sequence, and the second splicer comprises a second lug head which is cylindrical.

8. The middle frame of claim 5, wherein the first splicer and the second splicer are positioned at the same end of the splicing middle frame assembly.

9. The middle frame of claim 5, wherein the first splicer and the second splicer are respectively arranged at both ends of the splicing middle frame assembly, and are respectively matched with the guide grooves of the two different middle frame assemblies with the guide groove.

10. The middle frame of claim 1, wherein the middle frame assembly is configured with the guide groove; after the two adjacent middle frame assemblies are joined, the two guide grooves are partially overlapped, and the splicer is fixed in the overlapped guide groove of the two middle frame assemblies, and the two adjacent middle frame assemblies are positioned.

11. A backlight module, comprising:
a middle frame;
wherein the middle frame comprises at least two middle frame assemblies joined in sequence, and the middle frame further comprises a splicer; and
wherein a joining face of at least one of the middle frame assemblies is configured with a guide groove corresponding to at least two fixing positions, and the two adjacent middle frame assemblies are positioned by the splicer fixed in the guide groove.

12. The backlight module of claim 11, wherein the guide groove is a strip-shaped sliding chute; the middle frame assembly comprises a middle frame assembly with the guide groove and a splicing middle frame assembly; a joining face of the middle frame assembly with the guide groove is configured with the guide groove, and a joining face of the splicing middle frame assembly is configured with the splicer.

13. The backlight module of claim 12, wherein the guide groove comprises a fixing part with constant groove width; at least one end of the fixing part is configured with a guide part, and the groove width of the guide part is more than that of the fixing part; accordingly, both ends of the splicing middle frame assembly are configured with one splicer, respectively; the splicer is a lug head; the lug head comprises a root part connected with the splicing middle frame assembly and an end part connected with the root part; the width of the end part of the lug head is more than that of the root part, and is matched with that of the guide part of the guide groove, and the width of the root part of the lug head is matched with that of the fixing part of the guide groove; the two lug heads of the splicing middle frame assembly are respectively matched with the guide grooves of the two different middle frame assemblies with the guide groove.

14. The backlight module of claim 13, wherein both the fixing part and the guide part are in rectangle shape, and are axially symmetrical in the length direction of the guide groove;
accordingly, the root part and end part of the lug head are in cube shape, the end part is superposed on the root part, and the whole lug head is in a T shape.

15. The backlight module of claim 12, wherein the joining face of the middle frame assembly with the guide groove comprises a first joining face and a second joining face which are perpendicular to each other; the first joining face is configured with a first guide groove, and the second joining face is configured with a second guide groove; the joining face of the splicing middle frame assembly comprises a third joining face and a fourth joining face; the third joining face is configured with a first splicer matched with the first guide groove, and the fourth joining face is configured with a second splicer matched with the second guide groove.

16. The backlight module of claim 15, wherein the first guide groove comprises a fixing part with constant groove width; at least one end of the fixing part is configured with a guide part, and the groove width of the guide part is more than that of the fixing part; accordingly, the first splicer comprises a first lug head, and the first lug head comprises a root part connected with the splicing middle frame assembly and an end part connected with the root part; the width of the end part of the first lug head is more than that of the root part, and is matched with that of the guide part of the first guide groove; the width of the root part of the first lug head is matched with that of the fixing part of the first guide groove.

17. The backlight module of claim 15, wherein the second guide groove comprises a plurality of round holes which intersect in sequence, and the second splicer comprises a second lug head which is cylindrical.

18. The backlight module of claim 15, wherein the first splicer and the second splicer are positioned at the same end of the splicing middle frame assembly.

19. The backlight module of claim 15, wherein the first splicer and the second splicer are respectively arranged at both ends of the splicing middle frame assembly, and are respectively matched with the guide grooves of the two different middle frame assemblies with the guide groove.

20. The backlight module of claim 11, wherein the middle frame assembly is configured with the guide groove; after the two adjacent middle frame assemblies are joined, the two guide grooves are partially overlapped, and the splicer is fixed in the overlapped guide groove of the two middle frame assemblies, and the two adjacent middle frame assemblies are positioned.

21. An LCD device, comprising: the backlight module of claim 11.
